(19) United States
(12) Patent Application Publication
(10) Pub. No.: US 2008/0263865 A1
(43) Pub. Date: Oct. 30, 2008

(54) Method for the Production of an Armor Plating for a Blade Tip

(76) Inventors: Bernd Daniels, Grobenzell (DE); Katrin Friedberger, Neustadt/Rennsteig (DE)

Correspondence Address: GREER, BURNS & CRAIN, 300 S WACKER DR, 25TH FLOOR, CHICAGO, IL, 60606, US

(21) Appl. No.: 11/916,423

(22) PCT Filed: Jun. 23, 2006
(86) PCT No.: PCT/DE2006/001071

§ 371 Date: Jul. 7, 2008

(30) Foreign Application Priority Data
Jul. 1, 2005 (DE) 10 2005 030 848.1

(51) Int. Cl. B23P 15/04; B23K 1/00

(52) U.S. Cl. 29/889.71; 228/262.9; 228/122.1

(57) ABSTRACT

A method for producing a blade tip armor plating on a blade of a turbomachine, in particular on a high-pressure compressor rotary blade of a gas turbine, having the following steps: a) provision of a blade made of a nickel base material; b) application of a solder to a blade tip of the blade, the solder being a nickel base solder; c) application of hard material particles of cubic boron nitride to the solder, the hard material particles of cubic boron nitride being coated with titanium or with a titanium base material; d) fusion of the solder in a vacuum in order to form a matrix that at least partially surrounds the hard material particles; and e) fixing of the blade tip armor plating through cooling.

The present invention relates to a method for producing a blade tip armor plating on a blade of a turbomachine, in particular on a rotating high-pressure compressor blade of a gas turbine.

Turbomachines, such as gas turbine aircraft engines, generally comprise a plurality of stages having rotating blades as well as stationary guide blades, the rotating blades rotating together with a rotor, and both the rotating blades and the guide blades being enclosed by a stationary housing of the gas turbine. In order to increase the efficiency of an aircraft engine, it is important to optimize all the components and subsystems. This includes what are known as the sealing systems of aircraft engines. In aircraft engines, it is particularly problematic to maintain a minimum gap between the rotating blades and the stationary housing of a high-pressure compressor, as well as between the stationary guide blades and a rotating rotor shaft of the high-pressure compressor. This is because in high-pressure compressors there occur very high temperatures and large temperature gradients that make it difficult to maintain the gap. Inter alia, this is also due to the fact that in compressor rotary blades and in compressor guide blades, shrouds such as those used in turbines are omitted.

As already mentioned, the guide blades and the rotary blades in the compressor do not have a shroud. Therefore, ends or tips of the rotating rotary blades are exposed to direct frictional contact with the housing when what is known as blade rubbing takes place in the stationary housing. The free ends or tips of the guide blades are exposed to direct frictional contact with the rotor shaft. Such rubbing of the blade tips is caused by manufacturing tolerances when a minimum radial gap is set. Because the frictional contact of the blade tips thereon causes material to wear away, an undesirable enlargement of the gap can result over the entire circumference of the housing and rotor. In order to avoid this, from the prior art it is known to provide the ends or tips of the blades with a ceramic coating or to armor-plate them with particles of hard material or with abrasive particles, the blade tip armor plating being applied directly onto the blade tip that is to be armor-plated. According to the prior art, a blade tip armor plating formed from particles of hard material is soldered onto the blade tip that is to be armor-plated.

From DE 44 39 950 C2, a method is known for producing a blade tip armor plating on a blade that is made of a titanium base alloy, a solder being applied in layers to the blade made of the titanium base alloy by applying the elementary components of the solder, which comprises a composition adapted to the titanium base alloy of the blade, to the blade tip in layers in a graduated fashion. Particles of hard material are applied to the tip coated with the solder, and the solder components of the solder are subsequently fused on in order to sheath the hard material particles at least partially in a matrix. The method known from DE 44 39 950 C2 for producing a blade tip armor plating is suitable for use only in blades made of a titanium base alloy. Because high-pressure compressor blades are standardly made of a nickel base material or nickel base alloy, the method according to DE 44 950 C2 is not suitable for producing corresponding blade tip armor platings on blades of a high-pressure compressor of a gas turbine.

Based on this background, the present invention addresses the problem of creating a new method for producing a blade tip armor plating on a blade of a turbomachine.

This problem is solved by a method according to patent claim 1. According to the present invention, the method comprises at least the following steps: a) provision of a blade made of a nickel base material; b) application of a solder to a tip of the blade, the solder being a nickel base solder; c) application of hard material particles of cubic boron nitride to the solder, the hard material particles of cubic boron nitride being coated with titanium or with a titanium base material; d) fusing on of the solder in a vacuum to form a matrix that at least partially surrounds the hard material particles; e) fixing of the blade tip armor plating through cooling.

The method according to the present invention makes it possible to securely and effectively apply blade tip armor platings made of hard material particles even to blades made of a nickel base material or a nickel base alloy. According to the present invention, first a solder, i.e. a nickel base solder, is applied to a blade made of a nickel base material in the area of the blade tip. Subsequently, hard material particles of cubic boron nitride coated with titanium or with a titanium base material are applied to the solder. Together with the cubic boron nitride, the titanium forms a relatively thin titanium-nitride layer around the hard material particles, ensuring a good wetting with the nickel base solder. Accordingly, it is part of the present invention, in order to provide a blade tip armor plating on a blade made of a nickel base material, first to apply the nickel base solder to the tip of said blade, and subsequently to apply particles of cubic boron nitride coated with titanium or with a titanium base material to the nickel base solder, as hard material particles. Subsequent fusing on of the solder in a vacuum results in a stable bonding of the hard material particles to the tip of the blade.

Preferred developments of the present invention result from the subclaims and the following description. Exemplary embodiments of the present invention are explained in more detail on the basis of the drawing, without being limited thereto.

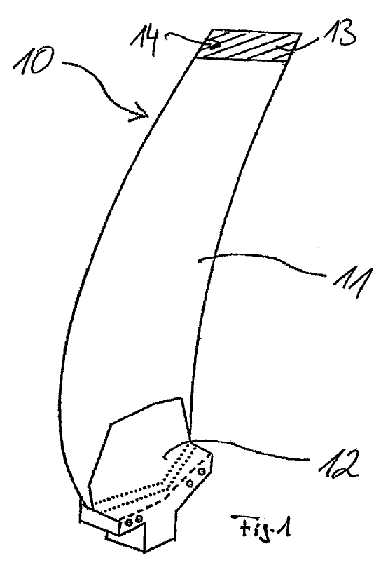

FIG. 1 shows a schematic view of a blade having a blade tip armor plating.

In the following, the present invention is described in greater detail with reference to FIG. 1.

FIG. 1 shows a schematized representation of a rotary blade of a high-pressure compressor of a gas turbine aircraft engine. Such high-pressure compressor rotary blades are made of a nickel base material or a nickel base alloy. Rotary blade 10 comprises a blade body 11 and a blade root 12. A radially external end of blade body 11 forms a blade tip 13. In order to protect blade tip 13 against wear when what is known as blade rubbing thereof occurs in a stationary housing, said blade tip bears a blade tip armor plating 14 made of hard material particles or having abrasive particles. The present invention relates to a new method for producing such a blade tip armor plating 14 on a blade made of a nickel base material.

According to the present invention for producing a blade tip armor plating, first a blade 10 made of a nickel base material or a nickel base alloy is provided. A nickel base solder is applied in the area of blade tip 13 of blade body 11 of said blade. According to the present invention, the nickel base solder, in the form of a solder film made of a homogenous solder material, is applied to blade tip 13, preferably by spot welding. Subsequently, hard material particles are applied to the solder film, namely hard material particles of cubic boron nitride coated with titanium or with a titanium base material. The application of the hard material particles coated with titanium or with a titanium base material to the solder film takes place with the aid of a binding agent, preferably an organic binding agent. The coating of the hard material particles of cubic boron nitride with titanium or with the titanium base material preferably takes place using a PVD process. After the hard material particles of cubic boron nitride coated with titanium or with the titanium base material have been applied to the solder film, there takes place a fusing on of the solder at soldering temperature in a vacuum, in order to enclose the hard material particles at least partially in a matrix and to bond them securely and fixedly to blade tip 13 of rotary blade 10. Through cooling, there takes place a fixing of blade tip armor plating 14 on blade tip 13 of rotary blade 10.

For the method according to the present invention for producing the blade tip armor plating, on the one hand it is important that a nickel base solder, preferably in the form of a homogenous solder film, be applied to a blade made of a nickel base material. In addition, it is important that hard material particles of cubic boron nitride coated with titanium or with a titanium base material be applied to the solder. The titanium of the coated hard material particles forms with the cubic boron nitride a relatively thin titanium-nitride coating around the hard material particles, thus insuring a good wetting with the nickel base solder. In this way, a good bonding of the hard material particles of cubic boron nitride to the nickel base solder, and thus to the blade tip, is ensured.

1-5. (canceled)

6. A method for producing a blade tip armor plating on a blade of a turbomachine, in particular on a high-pressure compressor rotary blade of a gas turbine, through application of a solder to a blade tip of the blade, the solder being a nickel base solder, subsequent application of hard material particles of cubic boron nitride to the solder, as well as fusion of the solder in a vacuum in order to form a matrix that at least partially surrounds the hard material particles, and fixing of the blade tip armor plating through cooling, wherein the hard material particles are coated with titanium or with a titanium base material and are applied to the solder with a binding agent.

7. The method as recited in claim 1, wherein the solder is applied to the blade tip as a solder film of a homogenous nickel base solder.

8. The method as recited in claim 2, wherein the solder film is applied to the blade tip by welding.

9. The method as recited in claim 1, wherein the hard material particles of cubic boron nitride are coated with the titanium or with the titanium base material by a PVD process before the application of said particles to the solder.
